(19) United States
(12) Patent Application Publication
(10) Pub. No.: US 2006/0268096 A1
(43) Pub. Date: Nov. 30, 2006

(54) Apparatus and method for image registration

(75) Inventor: Sung-tack Byun, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/439,203

(22) Filed: May 24, 2006

(30) Foreign Application Priority Data
May 24, 2005 (KR) 10-2005-0043760

(51) Int. Cl. B41J 2/47

(52) U.S. Cl. 347/232

(57) ABSTRACT

An image registration apparatus and method are provided for correcting image alignment errors irrespective of a possible black density loss in an image alignment correction process, in which a sensing unit senses first test patterns and second test patterns of cyan, magenta, yellow, and black, a reference value setting unit sets a reference value using the results of sensing the first test patterns obtained by the sensing unit, a comparing unit compares the reference value set by the reference value setting unit with the results of sensing the second test patterns obtained by the sensing unit; and a correcting unit corrects image alignment according to a comparison result of the comparing unit. Accordingly, the image registration apparatus and method controls the reference value which is compared with sensed voltages corresponding to test patterns.

### CROSS-REFERENCE TO RELATED PATENT APPLICATION

This application claims the benefit under 35 U.S.C. § 119(a) of Korean Patent Application No. 10-2005-0043760, filed on May 24, 2005, in the Korean Intellectual Property Office, the entire disclosure of which is hereby incorporated by reference.

### BACKGROUND OF THE INVENTION

1. Field of the Invention

The present invention relates to an image registration apparatus and method. More particularly, the present invention relates to an image registration apparatus and method for performing accurate image alignment irrespective of a possible black density loss in the process of image alignment correction.

2. Description of the Related Art

Generally, a color laser image forming apparatus including a developing unit and a photosensitive drum and forming images using a single pass scheme is referred to as a tandem type image forming apparatus. In a tandem type image forming apparatus, image forming starting points of black, cyan, magenta, and yellow must be aligned to obtain good quality images. However, the image forming starting points in the tandem type image forming apparatus may be misaligned due to changes in its configuration during manufacturing processes or by a long-time use. Such misalignment can be corrected using an auto color registration (ACR) method. In the ACR method, test patterns of black, cyan, magenta, and yellow are formed on a transfer belt, light reflected from each of the test patterns is detected using a photo sensor, and the detected light is converted into a voltage signal for a comparison with a reference value so that an alignment error of the color patterns is detected and corrected. However, since the transfer belt is in black, instead of a simple black test pattern, mixed test patterns of black and yellow are formed on the transfer belt as the black test pattern. Accordingly, the mixed test patterns of black and yellow are viewed as black due to mixed color characteristics.

FIG. 1 is a view illustrating an example of conventional test patterns of yellow Y, cyan C, magenta M, and black B. A black test pattern is expressed by a yellow portion 1 and a black portion 2. To obtain such a black test pattern, a yellow color is formed and a black color is then formed over the yellow color with a shape shown in FIG. 1.

However, if the density of the black formed on the yellow color is low, the black test pattern becomes obscure. Therefore, proper image registration is not achieved.

FIG. 2 is a graph illustrating voltages corresponding to the respective test patterns shown in FIG. 1. As mentioned above, reflected light voltages of the respective color test patterns are compared with reference values. In the case of the test patterns of yellow Y, cyan C, and magenta M, the voltages corresponding to the test patterns of the respective colors are relatively higher than the first and second reference values, so that the voltages can be useful for comparison for the image registration. In the black test pattern, the correct image registration is achieved with respect to the first reference value, but the black test pattern cannot be correctly recognized with respect to the second reference value due to a low density. Therefore, if the reference value is fixed, the image registration is not achieved correctly at the low black density.

Accordingly, there is a need for an improved image registration apparatus and method that corrects image alignment when low black density exists.

### SUMMARY OF THE INVENTION

An aspect of exemplary embodiments of the present invention is to address at least the above problems and/or disadvantages and to provide at least the advantages describe below. Accordingly, an aspect of exemplary embodiments of the present invention is to provide an image registration apparatus and method for correcting image alignment by properly controlling a reference value which is compared with sensed voltages corresponding to test patterns.

According to an aspect of exemplary embodiments of the present invention, there is provided an image registration apparatus, in which a sensing unit senses first test patterns and second test patterns of cyan, magenta, yellow, and black, a reference value setting unit sets a reference value using the results of sensing the first test patterns obtained by the sensing unit, a comparing unit compares the reference value set by the reference value setting unit with the results of sensing the second test patterns obtained by the sensing unit, and a correcting unit corrects image alignment according to a comparison result of the comparing unit.

According to another aspect of exemplary embodiments of the present invention, there is provided an image registration method, in which first test patterns of cyan, magenta, yellow, and black are sensed to set a reference value using the sensed results, the set reference value and the results of sensing second test patterns of cyan, magenta, yellow, and black are compared, and image alignment according to the comparison result is corrected.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of certain exemplary embodiments of the present invention will be more apparent from the following description taken in conjunction with the accompanying drawings, in which:

FIG. 1 is a view illustrating a conventional example of test patterns of colors;

FIG. 2 is a graph illustrating voltages corresponding to respective test patterns shown in FIG. 1;

FIG. 3 is a block diagram of the image alignment registration apparatus according to an exemplary embodiment of the present invention;

FIG. 4 is a view illustrating an example of test patterns of the image alignment registration apparatus shown in FIG. 3;

FIG. 5 is a view illustrating voltages corresponding to the test patterns shown in FIG. 4;

FIG. 6 is a flowchart illustrating an image alignment registration method according to an exemplary embodiment of the present invention; and

FIG. 7 is a flowchart illustrating setting a reference value shown in FIG. 6.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

FIG. 3 is a block diagram of an image alignment registration apparatus according to an exemplary embodiment of the present invention. The image alignment registration apparatus according to an exemplary embodiment of the present invention includes a sensing unit 100, reference value setting unit 120, comparing unit 130, correcting unit 140, and error message alarm unit 150.

The sensing unit 100 senses first test patterns of yellow, magenta, cyan, and black, and outputs the sensed results to the reference value setting unit 120. The sensing unit 100 senses second test patterns of yellow, magenta, cyan, and black, and outputs the sensed results to the comparing unit 130.

The sensing unit 100 is generally referred to as a registration sensor. The sensing unit 100 includes a light emitting unit (not shown), which radiates light. The sensing unit 100 also includes a light receiving unit (not shown) which receives the light radiated by the light emitting unit and reflected from the first and second test patterns, and converts the light into a voltage signal.

Among the first test patterns sensed by the sensing unit 100, the black test pattern is formed by mixing yellow and black, which is detected as black according to color mixture characteristics. In the black test pattern, the black distribution, for example, may be wider than the yellow distribution.

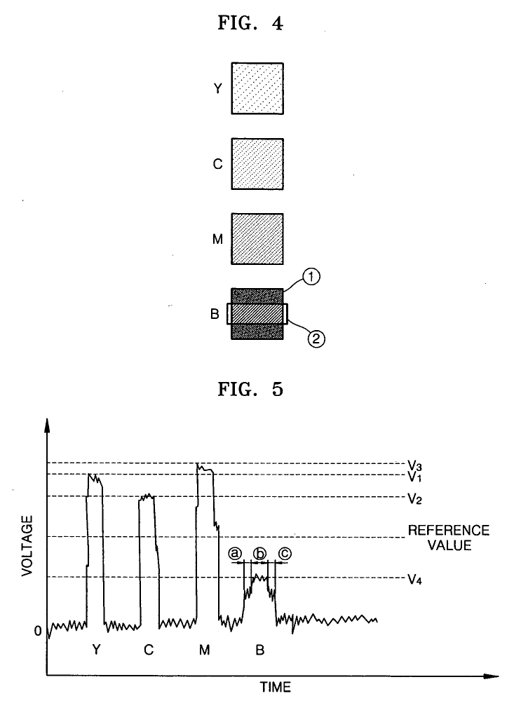

FIG. 4 is a view illustrating an example of the first test patterns for the image alignment registration apparatus according to an exemplary embodiment of the present invention. Referring to FIG. 4, the black test pattern includes a wide black portion 1 and a narrow yellow portion 2.

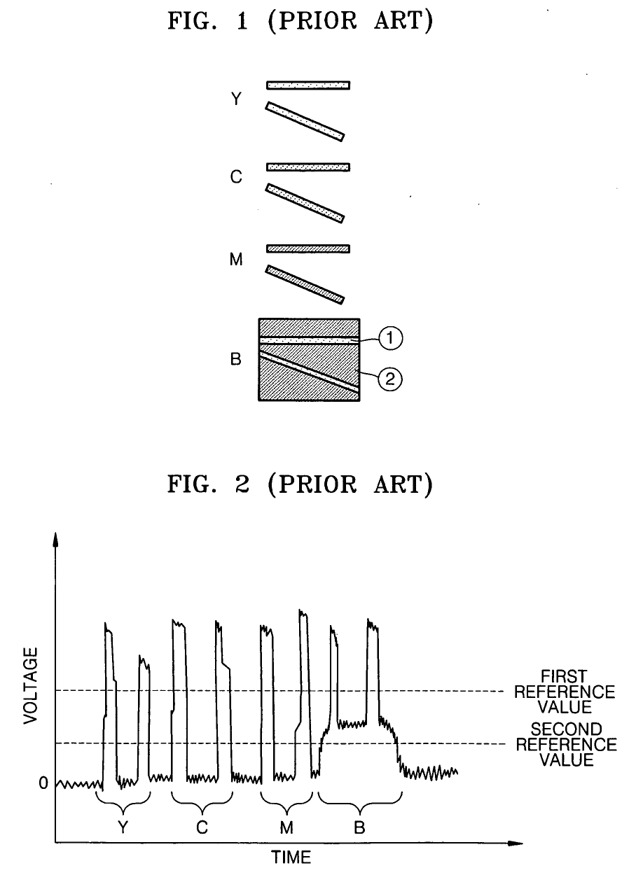

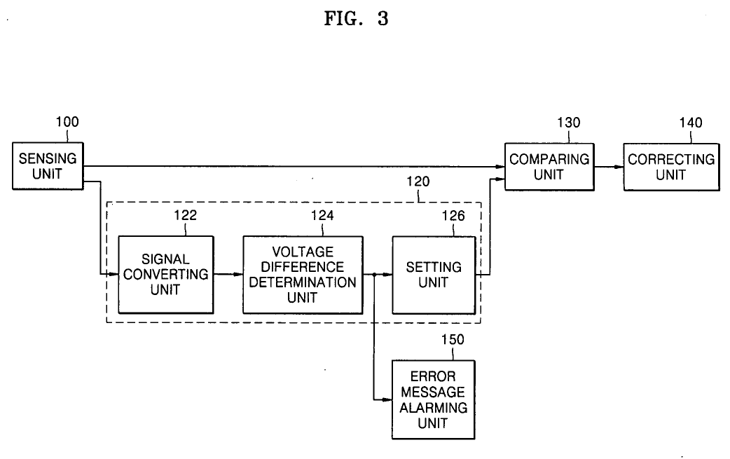

FIG. 5 is a graph illustrating voltages corresponding to the first test patterns shown in FIG. 4. The sensing unit 100 senses the test patterns of yellow, magenta, cyan, and black shown in FIG. 4. In an exemplary implementation, intervals a and c represent times when the light is reflected from the wide black portion 1, except from the narrow yellow portion 2. Further, interval b represents a time when the light is reflected from the narrow yellow portion. If the black density is high, the amount of the reflected light is low and the voltages corresponding to intervals a, b and c are difficult to distinguish. However, if the black density is low, a certain amount of the yellow is also exposed along with the black. Therefore, a relatively higher voltage is recognized at interval b than at intervals a and c. An example of the second test patterns sensed by the sensing unit is shown in FIG. 1.

The reference value setting unit 120 sets the reference value using the results of sensing the first test patterns obtained by the sensing unit 100, and outputs the set reference value to the comparing unit 130. The reference value is required to determine whether the output voltages corresponding to the reflected light from the respective test patterns are higher than a predetermined value. If the output voltages corresponding to the reflected light are higher than the reference value, a determination is made that the test patterns corresponding to the voltages are aligned.

The reference value setting unit 120 includes a signal converting unit 122, voltage difference determination unit 124, and setting unit 126.

The signal converting unit 122 converts the results of sensing the first test patterns in the sensing unit 100 into a digital signal and outputs the converted result to the voltage difference determination unit 124. The signal converting unit 122 may be an analog-digital converter.

The voltage difference determination unit 124 determines whether a sensed voltage difference between the voltage corresponding to the black test pattern and the voltage corresponding to the first test patterns of cyan, magenta, and yellow is less than the predetermined value. The voltage difference determination unit 124 then outputs the determination result to the setting unit 126 or the error message alarm unit 150. As shown in FIG. 5, the voltage difference determination unit 124 determines the difference between the sensed voltage V1 of the yellow test pattern and the sensed voltage V4 of the black test pattern, the difference between the sensed voltage V2 of the cyan test pattern and the sensed voltage V4 of the black test pattern, and the difference between the sensed voltage V3 of the magenta test pattern and the sensed voltage V4 of the black test pattern.

If all the determined voltage differences are higher than the predetermined value, the voltage difference determination unit 124 outputs determination results to the setting unit 126.

However, if at least one of the determined voltage differences is less than the predetermined value, the voltage difference determination unit 124 outputs the determination result to the error message alarm unit 150.

If the determined voltage differences are lower than the predetermined value, then a setting of the reference value between the sensed voltage corresponding to the black test pattern and the sensed voltages corresponding to the test patterns of cyan, magenta, and yellow may be difficult.

In response to the determination result of the voltage difference determination unit 124, the setting unit 126 sets reference values in a range between the sensed voltage of the black test pattern and sensed voltages of the test patterns of cyan, magenta, and yellow. The setting unit 126 then outputs the set reference voltage to the comparing unit 130. That is, as shown in FIG. 5, the set reference value is in a range between the sensed voltage V4 of the black test pattern and the sensed voltages V1, V2, and V3 of the test patterns of yellow, cyan, and magenta, respectively.

If the black density is low, a certain amount of the yellow is exposed along with the black. Therefore, relatively higher voltages are recognized at interval b than intervals a and c. With a conventional fixed reference value, if the reference value is less than the sensed voltage V4 corresponding to the black test pattern, an error may occur in the process of the image alignment registration. However, in an exemplary implementation, conventional image alignment errors can be avoided by setting the reference value in a range between the sensed voltage V4 corresponding to the black test pattern and the sensed voltages V1, V2, and V3 corresponding to the test patterns of yellow, cyan, and magenta.

The setting unit 126 sets average sensed voltages corresponding to the test patterns of yellow, magenta, cyan, and black as the reference value. Referring to FIG. 5, the setting unit 126 can set the reference value in a range between the sensed voltage V4 test patterns of yellow and the black test pattern, and the average of the sensed voltages V1, V2, and V3 corresponding to the test patterns of yellow.

In addition, the setting unit 126 sets the reference value in a range between the sensed voltage corresponding to the black pattern and a minimum voltage among the sensed voltages corresponding to the test patterns of yellow, magenta, and cyan. Referring to FIG. 5, the setting unit 126 can set the reference value in a range between the sensed voltage V4 corresponding to the black test pattern and the sensed voltage corresponding to the cyan test pattern V2, which is the minimum sensed voltage among the sensed voltages V1, V2, and V3 corresponding to the test patterns of yellow, cyan, and magenta.

The comparing unit 130 compares the results of sensing the second test patterns obtained by the sensing unit 100 with the reference value received from the reference value setting unit 120, and outputs a comparison result to the correcting unit 140. The reference value set by the reference value setting unit 120 is not the conventional fixed reference value, but a variable value which is set according to the sensed voltage corresponding to the black test pattern and the sensed voltages corresponding to the test patterns of cyan, magenta, and yellow. Accordingly, the comparing unit 130 may determine the alignment of the respective test patterns by comparing the reference value set by the reference value setting unit 120 with the output voltages corresponding to respective colors sensed by the sensing unit 100.

The correcting unit 140 corrects the alignment errors of the respective test patterns according to the comparison result of the comparing unit 130.

On the other hand, if the voltage difference determined by the voltage difference determination unit 124 is less than the predetermined value, the determination result is sent to the error message alarm unit 150, which an error message is sent to a user informing a possible image quality loss. If the determination voltage difference is less than the predetermined value, there is not enough black color to set the reference value. Therefore, the error message alarm unit 150 informs the user the shortage of the black color by creating the error message alarm or displaying the error message.

An image registration method according to an exemplary embodiment of the present invention will be described in detail with reference to the accompanying drawings.

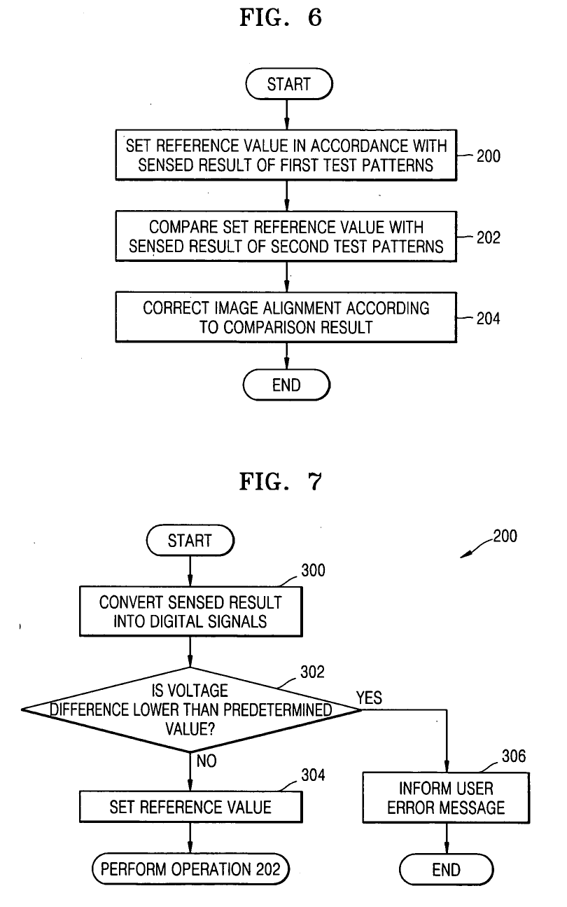

FIG. 6 is a flowchart illustrating an image registration method according to an exemplary embodiment of the present invention.

Referring to FIG. 6, the first test patterns of cyan, magenta, yellow, and black are sensed, and the reference value is set based on the sensed result (operation 200). Voltages corresponding to the sensed first test patterns are illustrated in FIG. 5.

The reference value is required to determine whether the output voltage corresponding to the light reflected from the test patterns of the respective colors is higher than the predetermined value.

Among the first test patterns, the black test pattern is formed by mixing yellow and black. In the black test pattern, a black distribution, for example, may be wider than yellow distribution.

FIG. 7 is a flowchart illustrating operation 200 shown in FIG. 6.

Referring to FIG. 7, the results of sensing the first test patterns are converted into digital signals (operation 300).

After operation 300, a determination is made as to whether the sensed voltage difference between the black test pattern and the first test patterns of cyan, magenta, and yellow is less than the predetermined value (operation 302).

As shown in FIG. 5, the difference between the sensed voltage V1 corresponding to the yellow test pattern and the sensed voltage V4 corresponding to the black test pattern, the difference between the sensed voltage V2 corresponding to the cyan test pattern and the sensed voltage V4 corresponding to the black test pattern, and the difference between the sensed voltage V3 corresponding to the magenta test pattern and the sensed voltage V4 corresponding to the black test pattern are all determined. If the determination voltage differences are lower than the predetermined value, setting the reference value may become difficult.

If the difference between the sensed voltage corresponding to the black test pattern and the sensed voltages corresponding to the test patterns of cyan, magenta, and yellow is higher than the predetermined value, the reference value is set to a value in a range between a digitalized sensed voltage corresponding to the black test pattern and digitalized sensed voltages corresponding to the test patterns of cyan, magenta, and yellow (operation 304).

For example, the reference value is set by averaging the sensed voltages of the test patterns of yellow, magenta, cyan, and black.

In addition, the reference value in a range between the sensed voltage corresponding to the black pattern and the minimum voltage among the sensed voltages corresponding to the test patterns of cyan, magenta, and yellow may be set as the reference value.

On the other hand, in operation 302, the error message indicating the possible image quality loss is sent to the user if the voltage difference between the sensed voltage corresponding to the black test pattern and the sensed voltage corresponding to the test patterns of cyan, magenta, and yellow is less than the predetermined value (operation 306). The error message is indicated to the users by creating an error message alarm or displaying the error message.

After operation 200, the set reference value is compared with the results of sensing the second test patterns of cyan, magenta, yellow, and black (operation 202). The reference value set in operation 200 is not a conventional fixed value, but includes the variable value which is set according to the sensed voltage corresponding to the black test pattern and the sensed voltages corresponding to the test patterns of cyan, magenta, and yellow.

After operation 202, the image alignment errors are corrected in accordance with the comparison result (operation 204).

Accordingly, an image registration apparatus and method according to exemplary embodiments of the present invention can accurately perform an image alignment correction irrespective of a possible black density loss in an image alignment correction process by properly controlling a reference value which is compared with sensed voltages corresponding to test patterns. Further, by informing a user of possible image alignment errors due to the black density loss before image alignment correction is carried out, inappropriate image alignment correction can be prevented.

The exemplary embodiments of the present invention may be written as computer readable code/instructions/programs and can be implemented in general-use digital computers that execute the programs using a computer readable recording medium. Examples of the computer readable recording medium include magnetic storage media (such as, ROM, floppy disks, hard disks, magnetic tapes, and the like), optical recording media (such as, CD-ROMs, or DVDs), and storage media such as carrier waves (such as, transmission through the Internet). Further, the computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image registration apparatus comprising:
a sensing unit for sensing first test patterns and second test patterns of cyan, magenta, yellow, and black;
a reference value setting unit for setting a reference value using the sensed results of the first test patterns;
a comparing unit for comparing the reference value with the sensed results of the second test patterns; and
a correcting unit for correcting image alignment according to the comparison result of the comparing unit.

2. The image registration apparatus according to claim 1, wherein the reference value setting unit comprises:
a signal converting unit for converting the results of the sensed first test patterns into digital signals; and
a setting unit for setting the reference value in a range between a sensed voltage corresponding to a black test pattern and sensed voltages corresponding to the first test patterns of cyan, magenta, and yellow.

3. The image registration apparatus according to claim 2, wherein the setting unit sets the reference value corresponding to an average of the sensed voltages corresponding to test patterns of cyan, magenta, yellow, and black.

4. The image registration apparatus according to claim 2, wherein the setting unit sets the reference value in a range between the sensed voltage corresponding to the black test pattern and a minimum voltage among the sensed voltages corresponding to the test patterns of cyan, magenta, and yellow.

5. The image registration apparatus according to claim 2, wherein the black test pattern is formed by mixing yellow and black.

6. The image registration apparatus according to claim 5, wherein the black test pattern is formed such that the distribution of black is wider than the distribution of yellow.

7. The image registration apparatus according to claim 2, wherein the reference value setting unit further comprises a voltage difference determination unit for determining whether a sensed voltage difference between the sensed voltage corresponding to the black test pattern and the sensed voltage corresponding to the test patterns of cyan, magenta, and yellow is less than a reference value.

8. The image registration apparatus according to claim 7, further comprising an error message alarm unit for informing of a possible image quality loss in response to a determination result indicating that the voltage difference is less than the reference value.

9. The image registration apparatus according to claim 8, wherein the error message alarm unit comprises at least one of sending an error message alarm and displaying an error message.

10. An image registration method comprising:
sensing first test patterns of cyan, magenta, yellow, and black to set a reference value;
comparing the set reference value and the results of sensed second test patterns of cyan, magenta, yellow, and black; and
correcting image alignment according to the comparison result.

11. The image registration method according to claim 10, wherein the sensing of the first test patterns comprises:
converting the results of sensing the first test patterns into digital signals; and
setting the reference value in a range between a digitalized sensed voltage corresponding to the black test pattern and digitalized sensed voltages corresponding to the first test patterns of cyan, magenta, and yellow.

12. The image registration method according to claim 11, wherein the setting of the reference value is set to an average of the sensed voltage corresponding to the test patterns of cyan, magenta, yellow, and black.

13. The image registration method according to claim 11, wherein the setting of the reference value is set in a range between the sensed voltage corresponding to the black test pattern and a minimum voltage among the sensed voltages corresponding to the test patterns of cyan, magenta, and yellow.

14. The image registration method according to claim 11, wherein the black test pattern is formed by mixing yellow and black.

15. The image registration method according to claim 14, wherein the black test pattern is formed so that the distribution of black is wider than the distribution of yellow.

16. The image registration method according to claim 11, wherein the sensing of the first test patterns further comprises determining whether the sensed voltage difference between the sensed voltage corresponding to the black test pattern and the sensed voltage corresponding to the test patterns of cyan, magenta, and yellow is less than a reference value.

17. The image registration method according to claim 16, further comprising:
outputting an error message informing of a possible image quality loss, if the voltage difference is less than the reference value.

18. The image registration method according to claim 17, wherein the outputting of the error message comprises at least one of sounding an error message alarm and displaying the error message.

19. A computer-readable medium comprising a computer program for performing the method of claim 10.

20. A computer-readable medium comprising a computer program for performing the method of claim 17.
